(19) United States
(12) Patent Application Publication
(10) Pub. No.: US 2026/0037193 A1
(43) Pub. Date: Feb. 5, 2026

(54) IMAGE FORMING APPARATUS, CONTROL METHOD, AND STORAGE MEDIUM

(71) Applicant: CANON KABUSHIKI KAISHA, Tokyo (JP)

(72) Inventor: KAZUKI SAMO, Kanagawa (JP)

(21) Appl. No.: 19/287,076

(22) Filed: Jul. 31, 2025

(30) Foreign Application Priority Data
Aug. 1, 2024 (JP) 2024-125977

(51) Int. Cl. G06F 3/12; G03G 15/00

(52) U.S. Cl. CPC G06F 3/1219; G03G 15/502; G06F 3/121; G06F 3/1221; G06F 3/1234; G06F 3/1259

(57) ABSTRACT

An image forming apparatus displays information about the image forming apparatus on a display unit, the display includes a predetermined screen including at least one of pieces of information about consumables for the image forming apparatus and at least one of pieces of information about environmental burden based on a job executed by the image forming apparatus.

### BACKGROUND

### Field of the Technology

The present disclosure relates to an image forming apparatus, a control method, and a storage medium.

### Description of the Related Art

In recent years, measures for making end users of image forming apparatuses that use consumables and consume power more aware of reducing environmental burden have been implemented. For example, Japanese Patent Application Laid-Open No. 2013-12198 describes a method for making users more aware of reducing environmental burden by displaying a report on environmental burden due to printing processing and decoloring processing (processing to decolor characters or images on used paper printed with ink that may be erased with heat).

There is a demand for more appropriately displaying a plurality of pieces of information about states of an image forming apparatus.

### SUMMARY

According to an aspect of the present disclosure, an image forming apparatus includes at least one memory storing a program and at least one processor that executes the stored program, which causes the at least one processor to display information about the image forming apparatus on a display unit, wherein displaying the information includes displaying a predetermined screen including at least one of pieces of information about consumables for the image forming apparatus and at least one of pieces of information about environmental burden based on a job executed by the image forming apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is an overall view of an image processing system according to a first embodiment.

FIG. 2 is a block diagram illustrating a hardware configuration of a multifunction peripheral (MFP) according to the first embodiment.

FIG. 3 is a block diagram illustrating a software configuration of the MFP.

FIGS. 4A to 4E are diagrams each illustrating an example of a screen that is displayed on an operation unit.

FIG. 5 is a flowchart illustrating operational status screen display processing.

FIG. 6 is a flowchart illustrating default screen display setting change processing.

FIGS. 7A and 7B are diagrams each illustrating an example of an operational status screen.

FIG. 8 is a diagram illustrating an example of a screen that is displayed on the operation unit.

FIG. 9 is a flowchart illustrating operational status screen display processing according to a third embodiment.

### DESCRIPTION OF THE EMBODIMENTS

The present disclosure will be described in detail below with reference to the drawings. The following embodiments do not limit the present disclosure and not all combinations of features described in the embodiments are necessarily essential to any solutions of the present disclosure. In the accompanying drawings, the same or similar reference numerals denote the same or similar components, and redundant descriptions are omitted.

### First Embodiment

A first embodiment of the present disclosure will now be described. The present embodiment illustrates an example in which both consumables information and environmental burden information that are described below are displayed on a screen.

### <System Configuration>

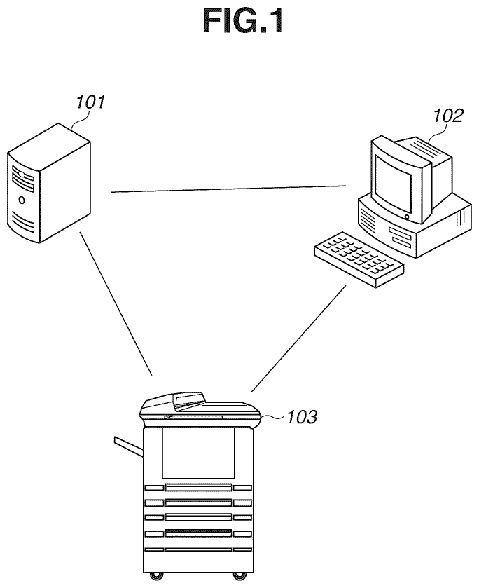

FIG. 1 is a schematic view illustrating a configuration of a system including an image forming apparatus according to the present embodiment.

The system according to the present embodiment is a system including a multifunction peripheral (MFP) 103 serving as an example of the image forming apparatus (image processing apparatus) connected on a network, a server personal computer (PC) 101 serving as an information processing apparatus, and a client PC 102 serving as an information processing apparatus. The image forming apparatus may be a printing apparatus (printer) including only a printing function for recording information on a print medium by using a recording material. For example, various devices, such as a PC, a smartphone, and a digital camera, may also be applied as the image forming apparatus according to the present embodiment.

The MFP 103 is a multifunction copying machine including a copy function for scanning a document to be copied and a printing function for printing print data received from, for example, an external printer driver. The MFP 103 includes the copy function and the printing function, as well as a function (send function) for transmitting image data generated by scanning a document to an external file server or an e-mail address. The MFP 103 may further include functions (such as a remote copy function and a facsimile function) for transmitting image data to a different MFP and printing the image data on the different MFP. The MFP 103 according to the first embodiment may use an electrophotographic printing method, an inkjet printing method, or any other printing method.

The MFP 103 is an example of a system that is connected to each information processing apparatus via Ethernet®. For example, the server PC 101 and the client PC 102 may be composed of the same computer, and the MFP 103 may be connected to a single information processing apparatus including the functions of the server PC 101 and the client PC 102. A configuration in which the server PC 101 and the client PC 102 are mounted on the MFP 103 may also be used. A terminal device or a smartphone may be used instead of a PC as each information processing apparatus that is used in the present embodiment.

### <Hardware Configuration of MFP>

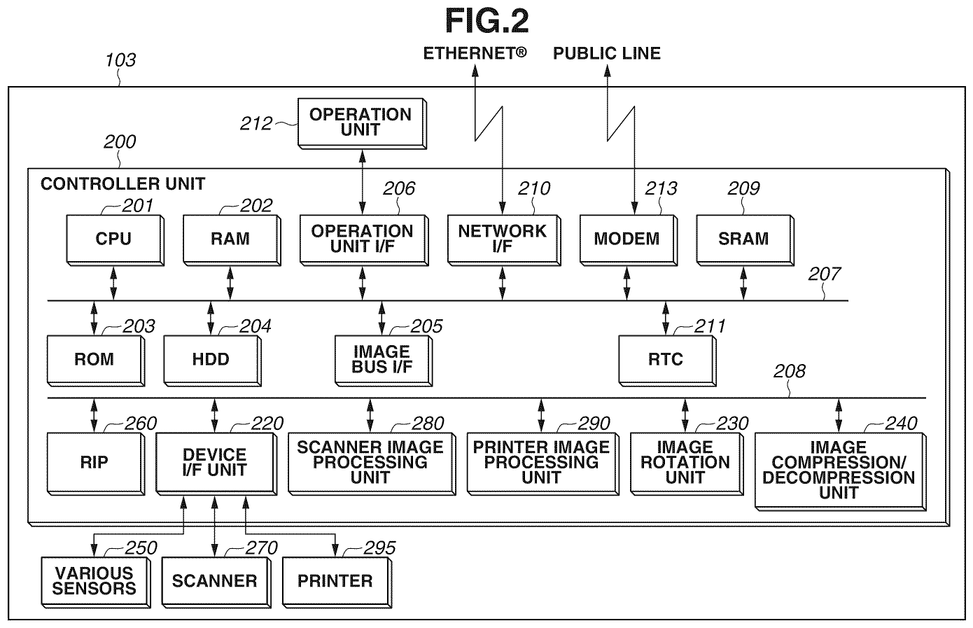

FIG. 2 is a block diagram illustrating a hardware configuration of the MFP 103 according to the first embodiment.

A controller unit 200 is connected to a scanner 270 serving as an image input device and a printer 295 serving as an image output device. The controller unit 200 may also be connected to Ethernet® or a public line to input and output image information and device information.

A central processing unit (CPU) 201 is a controller for controlling the MFP 103. A random access memory (RAM) 202 is a system working memory used for the CPU 201 to operate, and also functions as an image memory for temporarily storing image data. A read-only memory (ROM) 203 is a boot ROM and stores system boot programs. A hard disk drive (HDD) 204 stores system software, applications, and image data.

An operation unit interface (I/F) 206 is an interface unit for communication with an operation unit (display unit) 212 including a touch panel. The operation unit I/F 206 outputs image data to be displayed on the operation unit 212 to the operation unit 212. The operation unit I/F 206 also functions to transmit information input by a user using this system from the operation unit 212 to the CPU 201.

A static RAM (SRAM) 209 is a non-volatile recording medium that operates at high speed. A real-time clock (RTC) 211 performs processing of continuous counting of the current time even in a state where the controller unit 200 is powered off. The above-described devices are located on a system bus 207.

A network I/F 210 is connected to a network to input and output information. A modem 213 is connected to a public line to input and output information.

An image bus I/F 205 is a bus bridge that connects the system bus 207 to an image bus 208 for transferring image data at high speed and converts a data structure. The image bus 208 includes a peripheral component interconnect (PCI) bus or Institute of Electrical and Electronics Engineers (IEEE) 1394. A raster image processor (RIP) 260, a device I/F unit 220, a scanner image processing unit 280, a printer image processing unit 290, an image rotation unit 230, and an image compression/decompression unit 240 are located on the image bus 208.

The RIP 260 converts page description language (PDL) codes into a bitmap image. The device I/F unit 220 is connected to various sensors 250. The device I/F unit 220 obtains device states, connects image input/output devices, such as the scanner 270 and the printer 295, to the controller unit 200, and performs synchronous/asynchronous conversion on image data. The scanner image processing unit 280 performs correction, processing, and editing operations on input image data. The printer image processing unit 290 performs printer correction processing, resolution conversion processing, and the like on print output image data. The image rotation unit 230 performs rotation processing on image data. The image compression/decompression unit 240 performs compression/decompression processing.

### <Software Configuration of MFP>

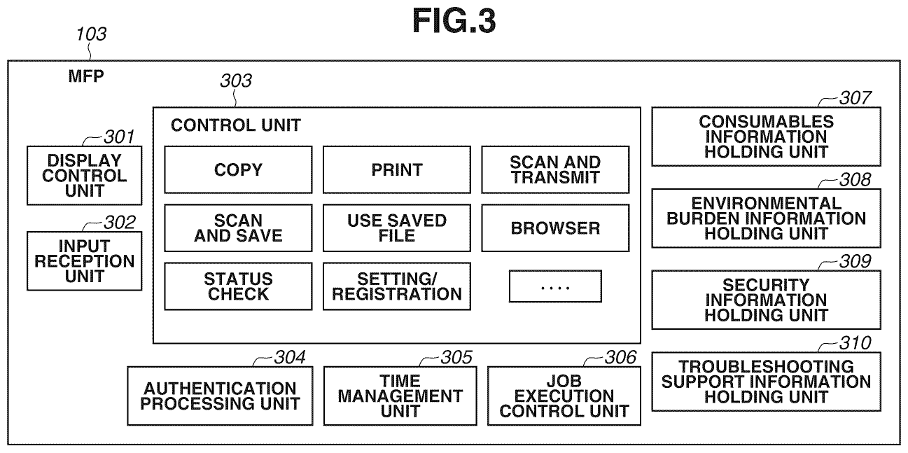

FIG. 3 is a block diagram illustrating a software configuration of the MFP 103. In the present embodiment, unless otherwise specified, exchange of data between illustrated software modules is implemented such that the CPU 201 performs processing based on programs stored in the ROM 203 or the HDD 204.

A display control unit 301 controls display of a screen for operating an application on the operation unit 212.

An input reception unit 302 receives an operation from the user on the operation unit 212 and transmits the received operation to a control unit 303. In the present embodiment, the input reception unit 302 receives operations including a user touch operation on the operation unit 212 and an operation on hardware keys included in the MFP 103 other than the operation unit 212.

The control unit 303 executes processing using applications corresponding to selected functions based on a user operation via the operation unit 212. Typical examples of the applications included in the MFP 103 are as follows:
an application program including a “copy” function in which image data generated by scanning an image on a document via the scanner 270 is printed by the printer 295.
an application program including a “print” function in which image data is printed by the printer 295 based on a print job input from an external device, such as a PC.
an application program including a “scan and transmit” function in which image data generated by scanning an image on a document by the scanner 270 is transmitted to an external device.
an application program including a “scan and save” function in which image data generated by scanning an image on a document by the scanner 270 is saved in an external memory.
an application program including a “use saved file” function in which image data saved in an external memory is printed by the printer 295 or is transmitted to an external device.
an application program including a “browser” function for browsing, printing, and saving data on a web server via a web browser.
an application program including a “status check” for displaying a status list of jobs being executed, or a history list of executed jobs.
an application program including a “setting/registration” function for providing a method of changing individual setting information (information set for each user account) and device setting information (not information set for each user account, but information uniquely set to each device).

The applications included in the MFP 103 are not limited to the above-described examples. Other applications may be added based on a user instruction.

An authentication processing unit 304 displays an authentication screen on the operation unit 212 and performs user authentication processing using authentication information, such as identification (ID) and a password, input from the user. When user authentication is successful, the authentication processing unit 304 performs login processing for the user to log into the MFP 103 based on user account (hereinafter also simply referred to as “user”) information. When a logout instruction is issued, the authentication processing unit 304 performs logout processing for the user to log out of the MFP 103.

A time management unit 305 manages an internal time of the MFP 103. In the present embodiment, for example, the internal time of the MFP 103 is used as a time stamp of an internal operation log. Based on the time stamp, an environmental burden information holding unit 308, described below, narrows down calculation targets of operation logs and environmental burden information on a display period pull-down menu during display of environmental burden information, which is described below. When an operation from the user on the input reception unit 302 has not been received for a predetermined period of time, the time management unit 305 starts timeout processing on the MFP 103.

A job execution control unit 306 executes a job in a case where processing to be executed by the control unit 303 is execution (pressing of a start button, etc.) of a job.

A consumables information holding unit 307 stores information about the remaining amount of consumables and the like detected by sensors (not illustrated) or the like. Specifically, the consumables information holding unit 307 stores information about the remaining amount of toner (toner remaining amount), which is a consumable that is used during printing processing, and the amount of recovered toner accumulated in a container for accumulating and recovering extra toner collected in printing processing. The consumables information holding unit 307 also stores information about the remaining number of sheets that is a consumable that is set in the MFP 103 and used during printing processing.

The environmental burden information holding unit 308 stores information about environmental burden (environmental burden information). Specifically, the environmental burden information holding unit 308 counts a total number of print copies, the number of sheets printed by monochrome (or color) printing, the number of sheets printed by double-sided printing, the number of sheets printed by N-in-one printing, and the like, and calculates a sheet reduction percentage, a monochrome printing (or color printing) percentage, a double-sided printing percentage, an N-in-one printing percentage, and the like, which are derived (calculated) from the pieces of information. The environmental burden information holding unit 308 calculates the amount of power consumed (amount of power consumption) in operation executed by the MFP 103 and stores information about the calculated amount of power consumption. These values are based on setting values of executed jobs and each indicate a predetermined percentage with respect to the total number of print copies. Detailed description of the calculation method is omitted. Information about the amount of power consumed in execution of jobs relative to the amount of power consumed during operation of the MFP 103 may also be stored. In the present embodiment, the environmental burden information holding unit 308 stores environmental burden information together with information indicating a date and time. Thus, the display control unit 301 displays environmental burden information in daily, weekly, and monthly format.

A security information holding unit 309 stores a current security setting of the MFP 103.

A troubleshooting support information holding unit 310 stores support information indicating a method for solving (resolving) an error or trouble that may occur in each application.

The configuration illustrated in FIG. 3 is merely an example and the software configuration of the MFP 103 is not limited to this example. A part of the configuration illustrated in FIG. 3 may be omitted or another configuration may be added to the configuration illustrated in FIG. 3.

The MFP 103 is generally maintained and operated by an administrator user (hereinafter referred to as an administrator) having a higher authority than general (individual) users as an authority to perform setting change processing and maintenance work on the MFP 103. Some administrators may be charged with taking appropriate measures (processing) based on information about the MFP 103, including checking the remaining amount of consumables, such as sheets and toner, and planning of replacement of consumables. In some cases, for example, the administrator may perform processing (operation), such as replacement of consumables in the image forming apparatus and repair and maintenance operations to resolve a failure part in the image forming apparatus. Specifically, for example, if the remaining amount of toner as consumables is considerably low, it can be considered that a failure related to toner has occurred. In a case of an occurrence of a failure related to toner, it may be desirable to perform a repair operation on the failure part. It may be difficult for the administrator to determine whether a failure related to toner has occurred or a large amount of toner has been used to print a number of copies. For example, in a case of an unusual low color printing percentage, it may be difficult for the administrator to determine whether the monochrome printing has been executed increased times because of the low remaining amount of color toner (whether it is necessary to replace toner), or the user has intentionally executed monochrome printing (whether there is no need to replace color toner). In other words, the information about consumables currently stored in the image forming apparatus may be insufficient for the administrator to determine appropriate processing to be performed on the image forming apparatus, which may lower the usability.

The present embodiment illustrates a configuration example in which the display control unit of the image forming apparatus appropriately displays information about the state of the image forming apparatus. Specifically, the display control unit of the image forming apparatus displays a plurality of different pieces of information about the state of the image forming apparatus for appropriate processing to be performed on the image forming apparatus on a single screen. More specifically, the display control unit of the image forming apparatus displays a predetermined screen including information about consumables currently stored in the image forming apparatus (information about consumables for the image forming apparatus when the predetermined screen is displayed) and information based on executed jobs, such as printing processing, executed on the image forming apparatus (information based on executed jobs, such as printing processing, executed during a predetermined period prior to display of the predetermined screen). The information based on executed printing processing on the image forming apparatus is information about environmental burden (environmental burden information) due to consumables used to execute jobs, such as printing processing, setting information about executed jobs, power consumption based on executed jobs and the operation of the MFP 103, and the like. The information will be described in detail below.

The above-described configuration in which the predetermined screen (single screen) including information about consumables and environmental burden information is displayed enables the user to easily recognize a plurality of different pieces of information about the state of the image forming apparatus that is referred to by the user to perform appropriate processing on the image forming apparatus without the need for performing an operation to shift to a plurality of screens. In other words, the above-described configuration facilitates the user to determine appropriate processing to be performed with respect to any event that occurs in the image forming apparatus due to multiple causes, which leads to an improvement in usability.

The, the display control unit of the image forming apparatus may display environmental burden information based on jobs, such as printing processing, executed during a predetermined period, on a predetermined screen. Specifically, the display control unit displays a pull-down menu for the user to select information indicating a predetermined period on the predetermined screen, to display environmental burden information based on jobs, such as printing processing executed during the predetermined period. The display control unit displays environmental burden information corresponding to the information indicating the predetermined period selected by the user.

Thus, since the environmental burden information based on jobs, such as printing processing executed during the predetermined period, is easily switched by the user, environmental burden information for each period can be easily compared, which leads to an improvement in usability.

The display control unit of the image forming apparatus controls display by switching between a predetermined screen (first area) including information about consumables and environmental burden information and a screen (second area) including information indicating an operation status of each job for which an execution instruction has issued in the image forming apparatus.

With this configuration, the user can easily switch the information about consumables and the environmental burden information, as well as the information indicating the operation status of each job for which the execution instruction has issued in the image forming apparatus. Thus, the user can determine appropriate processing to be perform on the image forming apparatus after recognizing more pieces of information. For example, if jobs for specific functions (printing, scanning, etc.) are determined to be in an NG state (non-executed state) on a consecutive base, the user switches the display to the first area and displays a troubleshooting screen by pressing a troubleshooting support button, described below, which increases the possibility of easily resolving the NG state. For example, if an out-of-paper error has occurred and printing processing is in the NG state, the user switches the display to the first area and refers to sheet information, whereby the user can easily recognize that the number of sheets is insufficient. If an increase or decrease in the number of print copies is recognized in the first area, the user switches the display to the second area, so that the user can easily check a user that has executed a large amount of printing processing.

While the present embodiment is described using a case in which the user that refers to the predetermined screen to perform appropriate processing with respect to the MFP 103 is an administrator, the user is not limited to an administrator, and may be a general user or another user with authority.

### <Operation Screen>

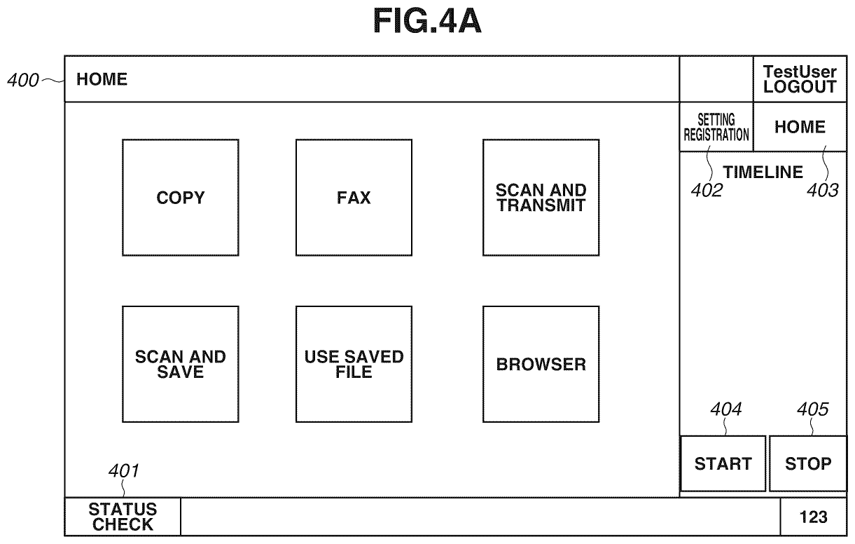

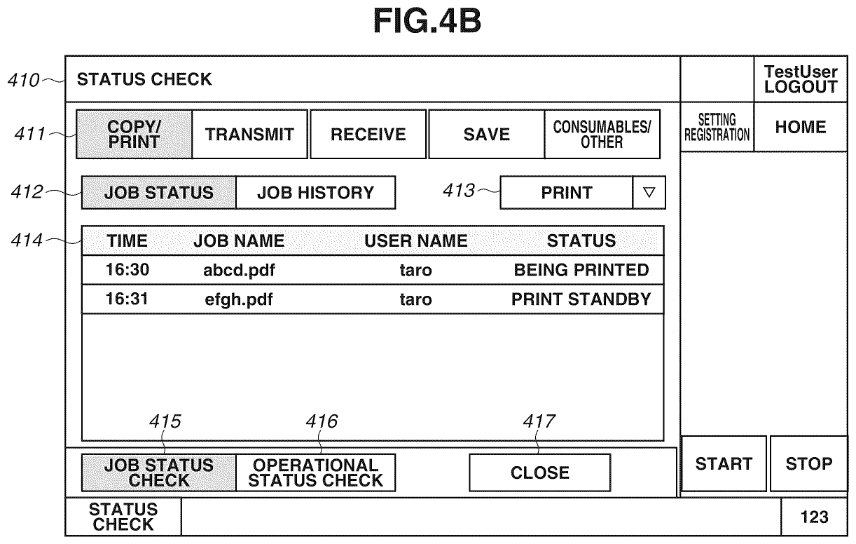

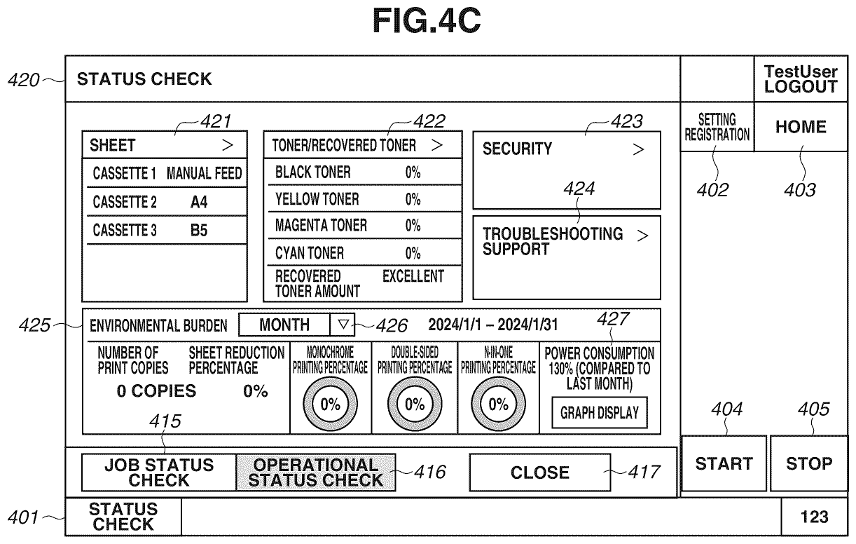

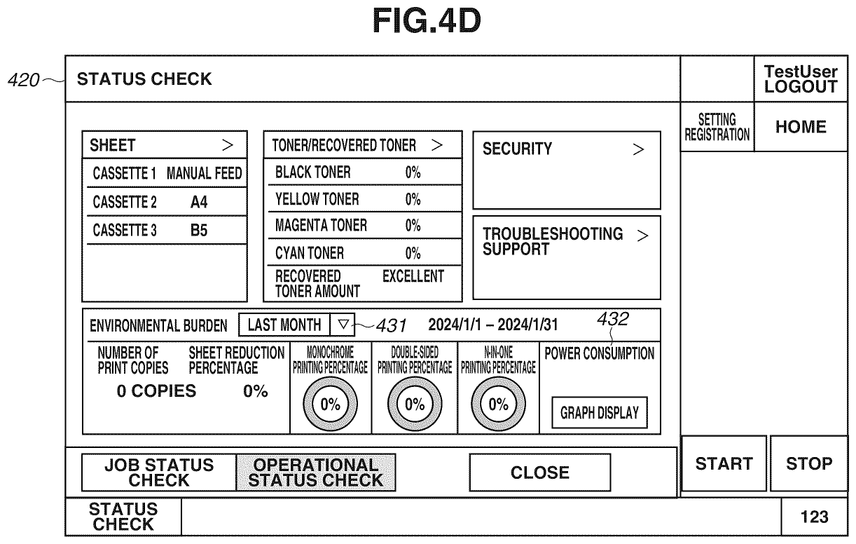

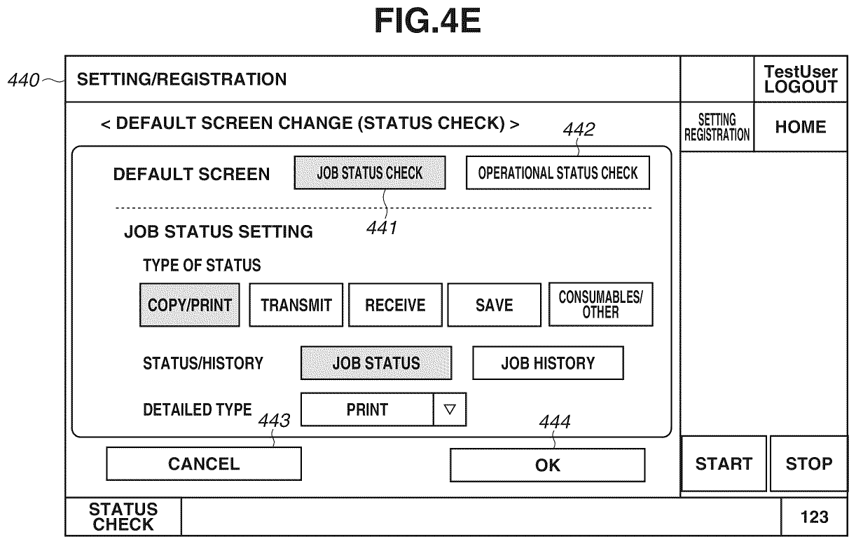

FIGS. 4A to 4E are diagram each illustrating an example of a screen that is displayed on the operation unit 212. Each of the screens illustrated in FIGS. 4A to 4E is displayed by the display control unit 301.

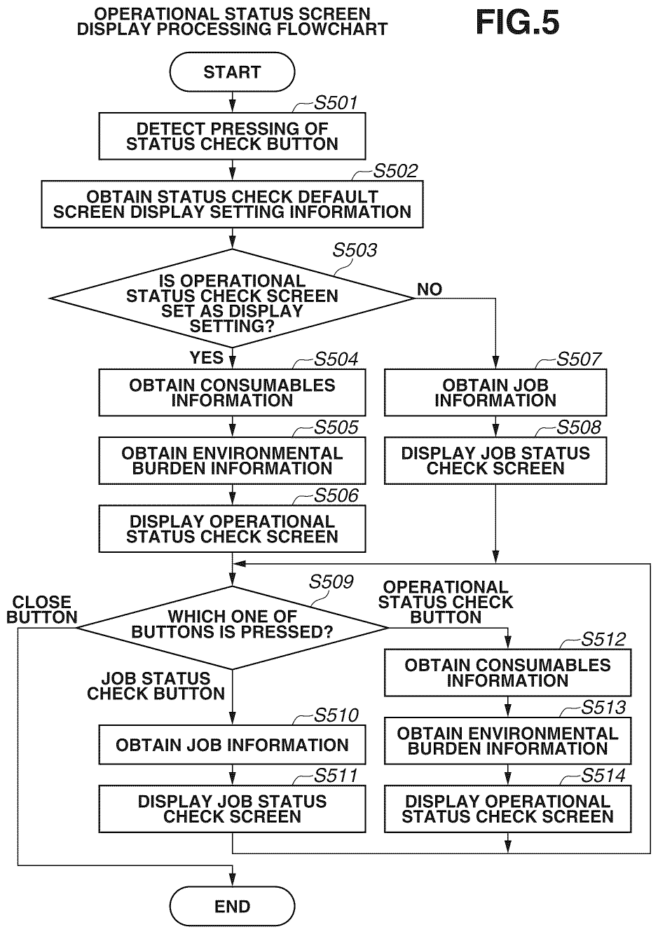

FIG. 4A illustrates an example of a home screen 400. The home screen 400 is a screen that is displayed in response to the starting of the MFP 103 or in response to the user pressing a home button 403 on another screen. The home screen 400 includes application buttons (icons, items, software keys) for executing the above-described applications. Specifically, for example, when a button indicating the “copy” function included in the home screen 400 is pressed, a setting screen on which setting values for the copy function may be set is displayed. This is applicable for buttons indicating other functions. Another button (custom button) indicating a function for which a setting value is set by the user may also be displayed on the home screen 400. When the custom button is selected, the setting screen in which the setting value set by the user is reflected is displayed. The screens illustrated in FIGS. 4A to 4E may also include shared buttons that are displayed even when the display shifts to another screen other than the home screen 400. The shared buttons include a status check button 401, a setting/registration button 402, the home button 403, a start button 404, and a stop button 405 and are displayed on each screen. When the status check button 401 is pressed by the user, a job status check screen 410 or an operational status check screen 420, described below, is displayed based on the processing illustrated in the flowchart of FIG. 5 described below. The status check button 401 is a button that may be pressed on the job status check screen 410 or the operational status check screen 420 as described below. In a case where the status check button 401 is pressed by the user in a state where the job status check screen 410 or the operational status check screen 420 is displayed on the display control unit 301, the displayed screen is closed and the home screen 400 or the authentication screen (not illustrated) is displayed. The screen displayed when the status check button 401 is pressed by the user in a state where the job status check screen 410 or the operational status check screen 420 is displayed on the display control unit 301 may be a screen other than the job status check screen 410 or the operational status check screen 420 currently displayed. When the setting/registration button 402 is pressed by the user, a setting/registration screen described below is displayed. The setting/registration button 402 is a button for displaying a setting screen (e.g., a default screen change (status check) screen 440 illustrated in FIG. 4E described below) for each setting item when the user presses from among buttons indicating the setting items of the setting/registration screen on the setting/registration screen. The home button 403 is a button for displaying the home screen 400 when the home button 403 is pressed by the user in a state where a screen other than the home screen 400 is displayed on the operation unit 212. The start button 404 is a button for starting to execute a job being displayed when the start button 404 is pressed by the user during display of the applications for executing jobs, such as a scan job and/or a print job. The stop button 405 is a button for displaying a check pop-up (not illustrated) to check whether to stop a job when the stop button 405 is pressed by the user during execution of the job. When the stop button 405 is pressed by the user in a state where there is no job being executed, a warning screen (not illustrated) indicating that there is no job being executed is displayed. When an OK button is pressed by the user on the check pop-up, the job being executed is cancelled.

FIG. 4B illustrates an example of the job status check screen 410. The job status check screen 410 is a screen that is displayed in response to pressing of the status check button 401 performed on the home screen 400 or a job status check button 415 on the operational status check screen 420 as described below. The job status check screen 410 includes a display category switch button 411, a display information switch button 412, a display application switch pull-down menu 413, a job list area 414, the job status check button 415, an operational status check button 416, and a close button 417. The display category switch button 411 is a button for the user to select a category of a job list to be displayed and to display the job list of the corresponding category on the job list area 414 when the display category switch button 411 is pressed by the user. As illustrated in FIG. 4B, examples of the category include “copy/print”, “transmit”, “receive”, “save”, and “consumables/other”. When the “consumables/other” category is selected, information (consumables remaining amount information) indicating the remaining amount of consumables in the MFP 103 is displayed. The display information switch button 412 is a button for displaying, when a job status button (button indicating a state of a job being executed) or a job history button (button indicating information about an executed job) is pressed, a job list corresponding to the pressed button on the job list area 414. The job status button or the job history button is in a selected state, while the other of the job status button and the job history button is in a non-selected state. The display application switch pull-down menu 413 is a pull-down menu that enables the user to select an application corresponding to a job to be displayed on the job list area 414 (an application included in the category). For example, when the display category switch button 411 is pressed to select the “copy/print” category, “job status” is selected on the display information switch button 412, and “print” is selected from the display application switch pull-down menu 413, the list of print jobs being executed is displayed on the job list area 414.

When the job status check button 415 is pressed by the user, the job status check screen 410 is displayed. When the job status check screen 410 is displayed on the operation unit 212, the job status check button 415 is displayed in a form (e.g., changed in color to yellow) indicating the selected state. When the operational status check button 416 is pressed by the user, the operational status check screen 420 described below is displayed. When the operational status check screen 420 is displayed on the operation unit 212, the operational status check button 416 is displayed in a form (e.g., changed in color to yellow) indicating the selected state. When the close button 417 is pressed by the user, the job status check screen 410 or the operational status check screen 420 currently displayed is closed (hidden) and a screen (e.g., home screen 400) displayed before the job status check screen 410 or the operational status check screen 420 is displayed is displayed.

FIG. 4C illustrates an example of the operational status check screen 420. The operational status check screen 420 is a screen that is displayed in response to pressing the status check button 401 or the operational status check button 416 on the job status check screen 410 by the user. The operational status check screen 420 includes consumables (sheet) information 421, consumables (toner) information 422, a security button 423, a troubleshooting support button 424, environmental burden information 425, a display period pull-down menu 426, and a period-over-period display 427. The sheet information 421 is information indicating the type, the remaining number, and the like of sheets set (stored) in each sheet cassette. The sheet information 421 is represented by a button, and when the sheet information 421 is pressed by the user, a sheet information detailed screen (not illustrated) is displayed. A gauge (icon) indicating the remaining number of sheets stored in each cassette may be displayed as the sheet information 421. The consumables information 422 is information indicating the toner remaining amount and the amount of recovered toner. As the consumables information 422, at least one of pieces of information including the toner remaining amount or the amount of recovered toner may be displayed. A gauge (icon) indicating the remaining amount of each color toner in the item of the toner remaining amount may be displayed, and a color icon indicating the color of each toner may be displayed. When an icon indicating the remaining amount of each toner is displayed, a number indicating a value (percentage) representing the remaining amount of each toner may or may not be displayed. The consumables information 422 is represented by a button, and when the consumables information 422 is pressed by the user, a consumables detailed screen (not illustrated) is displayed. When the security button 423 is pressed by the user, a detailed screen (not illustrated) related to security, such as the current security setting state in the MFP 103, is displayed. If the administrator has not logged into the MFP 103, the security button 423 is hidden. When the troubleshooting support button 424 is pressed by the user, a troubleshooting screen (not illustrated) for displaying information to provide a resolving and supporting service on an error or trouble that has occurred is displayed. The environmental burden information 425 includes information indicating a total number of print copies, a sheet reduction percentage, a monochrome printing percentage (or color printing percentage), a double-sided printing percentage, an N-in-one percentage, and the amount of power consumption. At least one of pieces of information, including the total number of print copies, the sheet reduction percentage, the monochrome printing percentage (or color printing percentage), the double-sided printing percentage, the N-in-one percentage, and the amount of power consumption, may be displayed as the environmental burden information 425. A different value (percentage) that is based on the setting value for the executed job and indicates a predetermined percentage with respect to the total number of print copies may be displayed. For example, a color reduction percentage may be displayed. Each piece of information included in the environmental burden information 425 is switched depending on the selected state of the display period pull-down menu 426. Specifically, options for the display period pull-down menu 426 may include “today”, “this week”, “this month”, and “last month”. For example, when “this week” is selected, environmental burden information total/calculation results based on jobs executed this week are displayed. As for each period, specifically, when “today” is selected, the period indicates a period (time) from 12:00 am on the day when the operation is performed to the current time. When “this week” is selected, the period indicates a period from a predetermined day of the week to the current time. When “this month” is selected, the period indicates a period from the beginning of the month to the current time. When “last month” is selected, the period indicates a period from the beginning of the month to the end of the month. The periods are not limited to the above-described examples, and a predetermined period of time and the number of days may be arbitrarily set. In the period-over-period display 427 for the amount of power consumption, a percentage of a display period selected from the display period pull-down menu 426 with respect to the previous total period is displayed. For example, when “today” is selected from the display period pull-down menu 426, the percentage of the total result for “today” with respect to the total result for the last day is displayed as the period-over-period display 427. When “last month” is selected from the display period pull-down menu 426 (state 431 illustrated in FIG. 4D), the period-over-period display 427 is hidden (state 432 illustrated in FIG. 4D). This is because when “last month” is selected, because the display contents are obtained by comparing the month before last month, the information is less likely (necessary) to be checked by the user at present time.

FIG. 4E illustrates an example of the default screen change (status check) screen 440 including information for setting and changing the default screen that is displayed when the status check button 401 is pressed. The default screen change (status check) screen 440 is a setting scree that is displayed by a user operation via the setting/registration screen displayed, for example, when the setting/registration button 402 or the like is pressed on the home screen 400. The default screen change (status check) screen 440 includes a job status check default setting button 441, an operational status check default setting button 442, a cancel button 443, an OK button 444, and the like. The job status check default setting button 441 is a button for setting a screen that is to be displayed when the status check button 401 is pressed on the job status check screen 410 when the status check button 401 is pressed by the user. The operational status check default setting button 442 is a button for setting a screen that is to be displayed in response to the status check button 401 being pressed on the operational status check screen 420 when the status check button 401 is pressed by the user. The job status check default setting button 441 or the operational status check default setting button 442 is in the selected state (e.g., changed in color to yellow), while the other of the job status check default setting button 441 or the operational status check default setting button 442 is in the non-selected state. A setting change performed on the default screen change (status check) screen 440 is temporarily stored. When the OK button 444 is pressed by the user with the setting change being stored, the setting change is reflected as device setting information. When the cancel button 443 is pressed, the held setting change information is deleted, and the screen is closed while the setting information obtained before the setting change is stored. The default screen change (status check) screen 440 may set information corresponding to the items of the display category switch button 411, the display information switch button 412, and the display application switch pull-down menu 413 as information to be displayed as default settings when the job status check screen 410 is displayed. The information is set based on selection by the user of each item illustrated in FIG. 4E.

### <Screen Display Processing>

FIG. 5 is a diagram illustrating an example of a flowchart of the operational status screen display processing. The flowchart illustrated in FIG. 5 is implemented by the CPU 201 of the MFP 103 loading programs for implementing control modules stored in the ROM 203 into the RAM 202 and executing the programs. Some or all of the functions in steps illustrated in FIG. 5 may be implemented by hardware, such as an application-specific integrated circuit (ASIC) or an electronic circuit. Reference symbol “S” used in the description of each process denotes a step in the flowchart.

In step S501, the input reception unit 302 starts processing of the flowchart in response to detection of pressing of the status check button 401.

In step S502, the control unit 303 obtains status check default screen display setting information set on the default screen change (status check) screen 440 illustrated in FIG. 4E. When the job status check default setting button 441 is in an enabled state (selected state), the control unit 303 obtains information indicating that the job status check screen 410 is set on the default screen. When the operational status check default setting button 442 is in the enabled state (selected state), the control unit 303 obtains information indicating that the operational status check screen 420 is set on the default screen.

In step S503, the control unit 303 determines, based on the status check default screen display setting information obtained in step S502, whether the display setting indicates the operational status check screen 420. Specifically, in a case where information indicating that the operational status check screen 420 is set has been obtained in step S502 (YES in step S503 in a case where the control unit 303 determines that the status check default screen display setting information indicates that the operational status check screen 420 is set in step S503), the processing proceeds to step S504. In a case where information indicating that the job status check screen 410 is set has been obtained in step S502 (NO in step S503 in a case where the control unit 303 determines that the status check default screen display setting information does not indicate that the operational status check screen 420 is set in step S503), the processing proceeds to step S507.

In step S504, the control unit 303 obtains consumables information from the consumables information holding unit 307.

In step S505, the control unit 303 obtains environmental burden information from the environmental burden information holding unit 308.

In step S506, the display control unit 301 displays the operational status check screen 420 illustrated in FIG. 4C.

After step S506, the processing in the flowchart may be terminated. For example, there may be a case that, after checking the operational status check screen 420, the user may leave the screen open and the time management unit 305 may start timeout processing after a lapse of time. In such a case, the display control unit 301 displays the home screen 400 or the authentication screen (not illustrated) after timeout processing and terminates the processing in the flowchart. Pressing of any of the above-described buttons illustrated in FIG. 4C may be detected in a state where the operational status check screen 420 is displayed. For example, when the security button 423 is pressed by the user, as described above, a security detailed screen (not illustrated) is displayed, and when the troubleshooting support button 424 is pressed by the user, the troubleshooting screen (not illustrated) is displayed.

In step S507 (NO in step S503), the control unit 303 obtains job information. For example, when a setting for displaying a print job status is set as the job status setting on the default screen change (status check) screen 440 illustrated in FIG. 4E, the control unit 303 obtains the status of the print job that is currently executed.

In step S508, the display control unit 301 displays the job status check screen 410 illustrated in FIG. 4B. After this step, the processing in the flowchart may be terminated. For example, there may be a case that, after checking the job status check screen 410, the user may leave the screen open and the time management unit 305 may start timeout processing after a lapse of time. In such a case, the display control unit 301 displays the home screen 400 or the authentication screen (not illustrated) after timeout processing and terminates the processing in the flowchart. After the job status check screen 410 is displayed, the user can press any of the above-described buttons illustrated in FIG. 4B. For example, when the display category switch button 411 is pressed by the user, as described above, the job list of the corresponding category is displayed on the job list area 414.

In step S509, the input reception unit 302 determines which one of the buttons is pressed. In a case where the input reception unit 302 determines that the job status check button 415 is pressed, the processing proceeds to step S510. In a case where the input reception unit 302 determines that the operational status check button 416 is pressed, the processing proceeds to step S512. In a case where the input reception unit 302 determines that the close button 417 is pressed, the displayed screen is closed and a previously displayed screen or a preliminarily set screen (e.g., home screen 400) is displayed, and then the processing in the flowchart ends. The user can also press any one of buttons other than the job status check button 415, the operational status check button 416, or the close button 417. The processing to be performed when each button is pressed correspond to the screens illustrated in FIGS. 4A, 4B, and 4C, respectively, as described above.

Steps S510 and S511 are similar to steps S507 and S508, respectively, and the redundant descriptions are omitted herein.

Steps S512 to S514 are similar to steps S504 to S506, respectively, and the redundant descriptions are omitted herein.

### <Setting Change Processing>

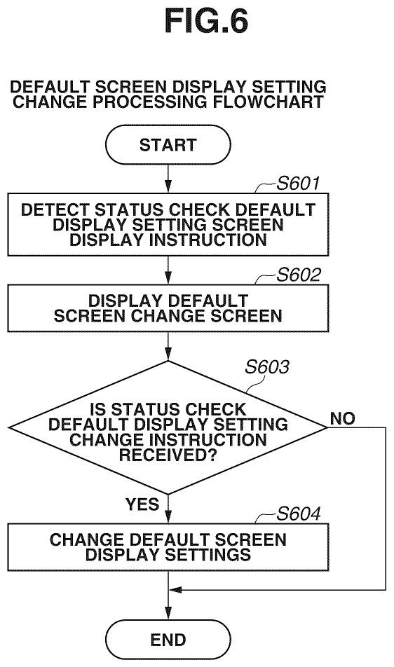

FIG. 6 is a diagram illustrating an example of a flowchart of the default screen display setting change processing. The flowchart illustrated in FIG. 6 is implemented by the CPU 201 of the MFP 103 loading programs for implementing control modules stored in the ROM 203 into the RAM 202 and executing the programs. Some or all of the functions in steps illustrated in FIG. 6 may be implemented by hardware, such as an ASIC or an electronic circuit.

The flowchart illustrated in FIG. 6 is started based on display of the setting/registration screen displayed in response to the setting/registration button 402 being pressed on the home screen 400 or the like.

In step S601, the input reception unit 302 detects an instruction to display a status check default display setting screen.

In step S602, the display control unit 301 displays the default screen change (status check) screen 440 illustrated in FIG. 4E.

In step S603, the input reception unit 302 determines whether a status check default display setting change instruction is received. In a case where the setting button on the default screen change (status check) screen 440 is operated by the user and the OK button 444 is pressed, it is determined that the setting change instruction is received. In a case where the input reception unit 302 determines that the setting change instruction is received (YES in step S603), the processing proceeds to step S604. In a case where the input reception unit 302 determines that the setting change instruction is not received (NO in step S603) (for example, in a case where the cancel button 443 is pressed), the processing in the flowchart ends.

In step S604, the control unit 303 reflects the content of the received setting change as the device setting, and then the processing in the flowchart ends.

As described above, in the present embodiment, the display control unit of the image forming apparatus more appropriately displays information about the state of the image forming apparatus. Specifically, the display control unit of the image forming apparatus displays a plurality of different pieces of information about the state of the image forming apparatus that is referred to by the user to perform appropriate processing on the image forming apparatus on a single screen. More specifically, the display control unit of the image forming apparatus displays a predetermined screen including information about consumables currently stored in the image forming apparatus (information about consumables of the image forming apparatus when the predetermined screen is displayed) and information based on executed jobs, such as printing processing on the image forming apparatus (information based on executed jobs such as printing processing executed during a predetermined period prior to display of the predetermined screen). The information based on executed printing processing on the image forming apparatus is environmental burden information about consumables used in executed jobs such as printing processing, setting information about executed jobs, power consumption based on executed jobs, and the like.

With the configuration in which the predetermined screen (single screen) including the information about consumables and the environmental burden information is displayed, the user can easily recognize a plurality of different pieces of information about the state of the image forming apparatus that is referred to by the user to perform appropriate processing on the image forming apparatus, without the need for performing an operation to shift to a plurality of screens. In other words, the above-described configuration facilitates the user to determine appropriate processing to be performed with respect to any event that occurs in the image forming apparatus due to multiple causes, which leads to an improvement in usability.

The display control unit of the image forming apparatus may display environmental burden information based on jobs, such as printing processing executed during a predetermined period, on the predetermined screen. Specifically, the display control unit displays a pull-down menu for the user to select information indicating the predetermined period on the predetermined screen, to display environmental burden information based on jobs such as printing processing executed during the predetermined period, and displays environmental burden information corresponding to the information indicating the predetermined period selected by the user on the predetermined screen.

This configuration enables the user to switch the environmental burden information based on jobs, such as printing processing executed during the predetermined period, whereby the user can easily compare the environmental burden information for each period, which leads to an improvement in usability.

The display control unit of the image forming apparatus controls display to be switchable between the predetermined screen (first area) including the information about consumables and the environmental burden information, and the screen (second area) including information indicating the operation status of each job for which the execution instruction has been issued in the image forming apparatus.

This configuration facilitates the user to switch the information about consumables and the environmental burden information, as well as the information indicating the operation status of each job for which the execution instruction has been issued in the image forming apparatus. Therefore, the user can determine appropriate processing to be performed on the image forming apparatus after recognizing more pieces of information.

### Second Embodiment

Next, a second embodiment will be described. The first embodiment described above illustrates an example of providing a method for displaying consumables remaining amount information and environmental burden information on a single screen, whereby the user can easily recognize a plurality of pieces of information to perform appropriate processing on the image forming apparatus without the need for performing an operation to shift to a plurality of screens. However, when the user has little knowledge about the method and has barely managed to recognize the consumables remaining amount information and the environmental burden information, it may be difficult for the user to determine and perform appropriate processing based on the pieces of information. Accordingly, the present embodiment illustrates a case where a support screen for the user to perform appropriate processing on the image forming apparatus based on consumables remaining amount information and environmental burden information is displayed.

The present embodiment differs from the first embodiment in that a job troubleshooting support button 701 is provided instead of the troubleshooting support button 424 and a device troubleshooting support button 702 is provided on the screen illustrated in FIG. 4C.

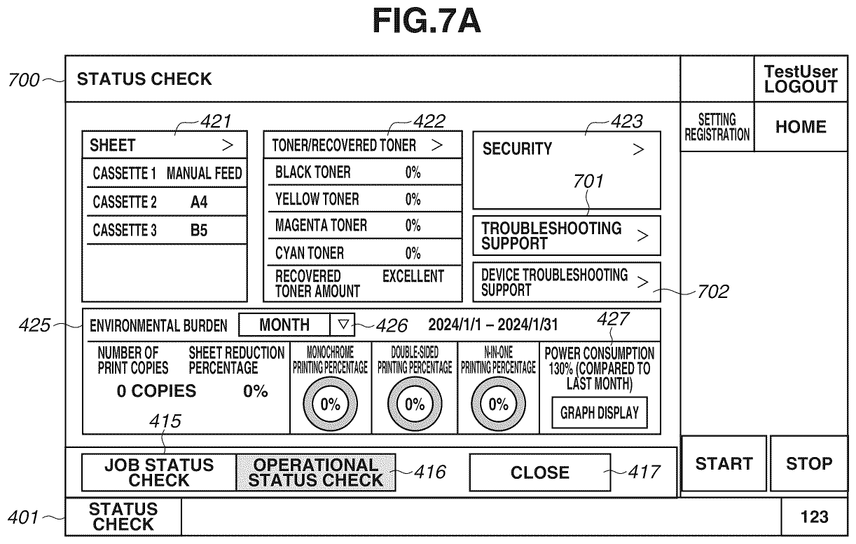

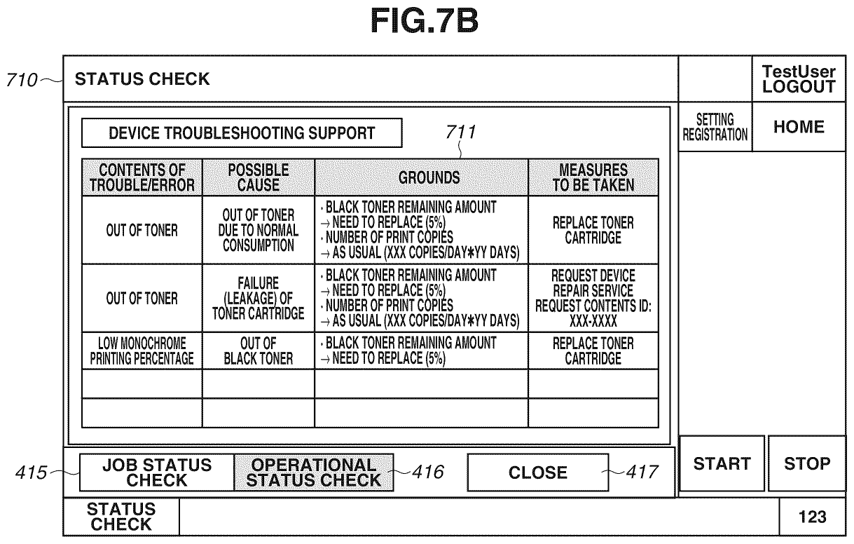

FIGS. 7A and 7B are diagrams each illustrating an example of an operational status screen 700. The operational status screen 700 is displayed by the display control unit 301.

FIG. 7A illustrates an example of the operational status screen 700. The operational status screen 700 includes the job troubleshooting support button 701 and the device troubleshooting support button 702. The job troubleshooting support button 701 is a button for providing a function similar to the function of the troubleshooting support button 424 according to the above-described first embodiment. When the device troubleshooting support button 702 is pressed by the user, a device troubleshooting support screen 710 (FIG. 7B) is displayed.

FIG. 7B illustrates an example of the device troubleshooting support screen 710. A solution list 711 is displayed on the device troubleshooting support screen 710. A list of pieces of information indicating solutions based on the contents of potential (estimated) errors or troubles based on information displayed on the operational status screen 700 is displayed on the solution list 711. The solution list 711 includes information about possible causes and grounds of the errors or troubles. Even when the contents of the errors or troubles are the same, different necessary solutions are displayed in a case where possible causes of the error or troubles based on information about the grounds are different.

As described above, according to the present embodiment, the administrator of the MFP 103 can recognize a plurality of pieces of information for management and operation at once, and can easily check a method to determine contents of necessary measures based on the information.

While the present embodiment illustrates an example of displaying solutions on another screen, the present embodiment is not limited to this example. Specifically, possible errors or troubles may be displayed on the operational status screen 700, and information associated with the errors or troubles may be displayed on the device troubleshooting support button 702.

While the present embodiment illustrates an example case in which contents of measures are displayed on the device troubleshooting support screen 710, the present embodiment is not limited to this example. Specifically, for example, in a case where a screen for repair service (not illustrated) or the like is present, a guidance button to shift to the screen for repair service may be displayed.

While the present embodiment illustrates an example case in which the device troubleshooting support button 702 is constantly displayed, the present embodiment is not limited to this example. For example, the device troubleshooting support button 702 may be controlled to be displayed on the operational status screen 700 only when a certain condition that may require some measures is satisfied. Specifically, the device troubleshooting support button 702 may be controlled to be displayed on the operational status screen 700 only when an error or trouble, such as a state where the toner remaining amount is less than or equal to a predetermined threshold, occurs.

### Third Embodiment

Next, a third embodiment will be described. The first embodiment described above illustrates a method for switching display between the operational status check screen and the job status check screen based on the default screen setting. Since there are various users, some users, such as the administrator and general users, that use the MFP 103 may wish to set the operational status check screen as the default screen, while other users may wish to set the job status check screen as the default screen. Thus, the present embodiment illustrates an example of a method for setting default screen settings for each user account information and switching the default screen to be displayed for each user that has logged into the MFP 103.

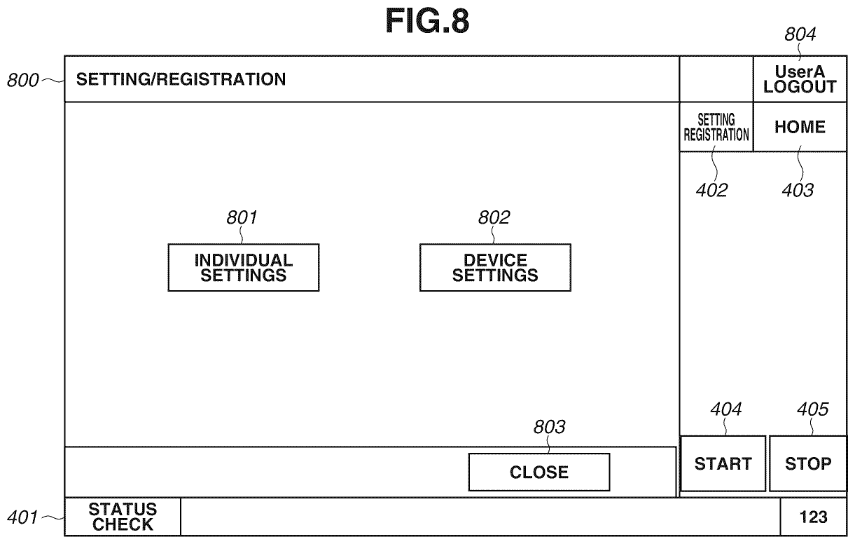

FIG. 8 is a diagram illustrating an example of a screen to be displayed on the operation unit 212. The screen illustrated in FIG. 8 is displayed by the display control unit 301.

FIG. 8 illustrates an example of a setting change screen 800. The setting change screen 800 is a screen that is displayed in response to pressing performed on the setting/registration button 402 on the home screen 400 in a state where the user has logged into the MFP 103. The present embodiment illustrates an example case in which a user as a user A has logged into the MFP 103. The setting change screen 800 includes an individual settings button 801, a device setting button 802, a close button 803, and a logout button 804. In response to the individual settings button 801 being pressed, the setting/registration screen for the individual user (user A that has logged in) is displayed. Next, in response to a predetermined button from among the buttons respectively corresponding to items on the displayed setting/registration screen being pressed by the user, a predetermined setting screen (e.g., default screen change (status check) screen 440 illustrated in FIG. 4E) is displayed. Then, in a case where a setting operation as described above with reference to FIG. 4E is performed on the predetermined setting screen, information based on the setting operation is reflected as a setting (first setting) for the individual user (user A that has logged in). In response to the device setting button 802 being pressed, the setting/registration screen for device setting is displayed. Next, in response to a predetermined button from among the buttons respectively corresponding to the items on the displayed setting/registration screen being pressed by the user, a predetermined setting screen (e.g., default screen change (status check) screen 440 illustrated in FIG. 4E) is displayed. In a case where a setting operation as described above with reference to FIG. 4E is performed on the predetermined setting screen, the setting operation is reflected as the device setting (second setting). The device setting refers to a unified (fixed) setting of the device regardless of the login user. When the user uses the MFP 103 without logging into the MFP 103, the MFP 103 operates with reference to the device setting. In response to the close button 803 being pressed, the setting change screen 800 is closed and a screen displayed before the setting change screen 800 is displayed, or a preliminarily set screen (e.g., home screen 400) is displayed. In response to the logout button 804 being pressed, the user that has logged into the MFP 103 logs out, so that the setting/registration operation is cancelled. Consequently, for example, the screen returns to an initial screen, such as the home screen 400. User information (user A) is displayed on the logout button 804. FIG. 8 illustrates an example case in which the setting/registration button 402 is pressed on the home screen 400 in a state where the user has logged in. However, in a case where the user has not logged in, the user cannot make any individual settings, and thus the setting/registration screen for device setting may be directly displayed without displaying the setting change screen 800 (in the same manner as in the first embodiment). Alternatively, the authentication screen (not illustrated) may be displayed to receive login processing and perform login authentication in response to the individual settings button 801 being pressed after the setting change screen 800 is displayed, and then the setting/registration screen for the individual user that has logged in may be displayed.

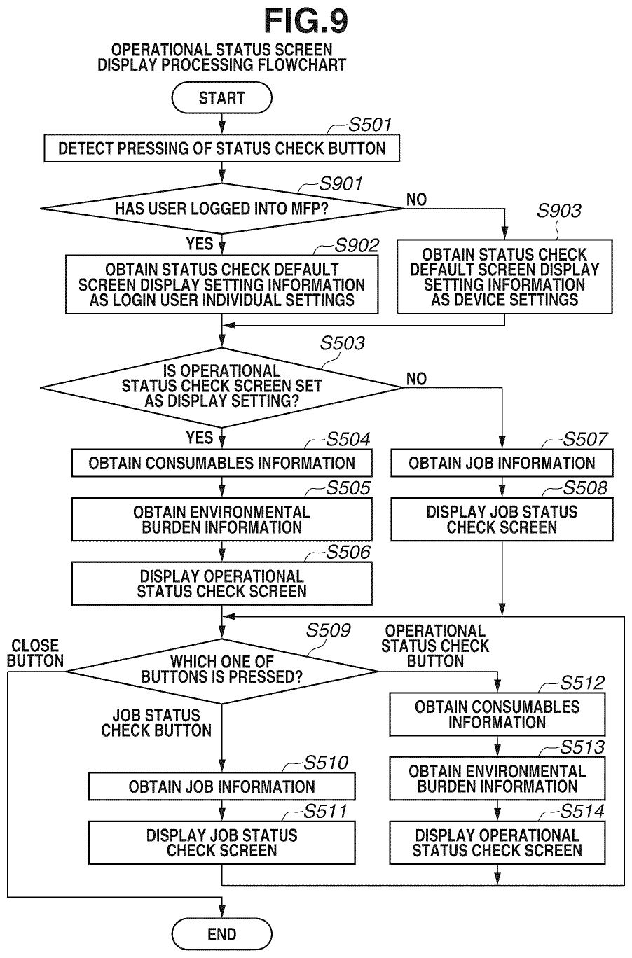

FIG. 9 is a diagram illustrating an example of a flowchart of operational status screen display processing according to the present embodiment. The flowchart illustrated in FIG. 9 is implemented by the CPU 201 of the MFP 103 loading programs for implementing control modules stored in the ROM 203 into the RAM 202 and executing the programs. Some or all of the functions in steps illustrated in FIG. 9 may be implemented by hardware, such as an ASIC or an electronic circuit. Processes similar to those of the first embodiment (FIG. 5) are denoted by the same step numbers, and the redundant descriptions are omitted herein.

In step S901, the control unit 303 determines whether the user has logged into the MFP 103. In a case where the control unit 303 determines that the user has logged into the MFP 103 (YES in step S901), the processing proceeds to step S902. In a case where the control unit 303 determines that the user has not logged into the MFP 103 (NO in step S901), the processing proceeds to step S903.

In step S902, the control unit 303 obtains information about the user that has logged into the MFP 103, and obtains status check default screen display setting information that has been set on the default screen change (status check) screen 440 as login user individual settings.

In step S903, the control unit 303 obtains status check default screen display setting information that has been set on the default screen change (status check) screen 440 for device settings.

As described above, according to the present embodiment, default screen settings can be set for each user. Specifically, in a case where the administrator has logged into the MFP 103, the operational status check screen is displayed as the default screen, and in a case where the general user has logged into the MFP 103, the job status check screen is displayed. In other words, the display of the default screen that is to be displayed in response to the status check button 401 being pressed can be switched for each of different users that use the MFP 103 for different purposes, which leads to an improvement in usability.

A plurality of pieces of information about the state of the image forming apparatus is more appropriately displayed.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-125977, filed Aug. 1, 2024, which is hereby incorporated by reference herein in its entirety.

What is claimed is:

1. An image forming apparatus comprising:
at least one memory storing a program; and
at least one processor that executes the stored program, which causes the at least one processor to:
display information about the image forming apparatus on a display unit,
wherein displaying the information includes displaying a predetermined screen including at least one of pieces of information about consumables for the image forming apparatus and at least one of pieces of information about environmental burden based on a job executed by the image forming apparatus.

2. The image forming apparatus according to claim 1, wherein the information about the consumables is at least one of information about a remaining amount of toner stored in the image forming apparatus or information about a remaining number of sheets stored in a cassette of the image forming apparatus.

3. The image forming apparatus according to claim 1, wherein the information about the environmental burden is at least one of a total number of print copies, a sheet reduction percentage, a monochrome printing percentage, a double-sided printing percentage, an N-in-one printing percentage, or an amount of power consumption.

4. The image forming apparatus according to claim 1, wherein the predetermined screen displays an item for displaying information about a security status of the image forming apparatus.

5. The image forming apparatus according to claim 1, wherein the predetermined screen displays an item for displaying information for resolving an error that occurred in the image forming apparatus.

6. The image forming apparatus according to claim 1, wherein the predetermined screen displays a potential error that occurred in the image forming apparatus based on the at least one of pieces of information about consumables for the image forming apparatus and the at least one of pieces of information about environmental burden based on a job executed by the image forming apparatus, and an item for displaying a screen including at least information for resolving the potential error.

7. The image forming apparatus according to claim 1, wherein the information about environmental burden is displayed by different periods on the predetermined screen.

8. The image forming apparatus according to claim 1, wherein a pull-down menu is displayed for selection of a period during which the information about environmental burden is displayed on the predetermined screen.

9. The image forming apparatus according to claim 8, wherein the information about environmental burden is displayed based on the period selected from the pull-down menu.

10. The image forming apparatus according to claim 9, wherein information indicating the period displayed on the pull-down menu includes information indicating periods respectively corresponding to a current day, a current week, a current month, or a previous month.

11. The image forming apparatus according to claim 8, wherein, in a case where information indicating a previous month is selected from the pull-down menu, a part of the information about environmental burden is not displayed.

12. The image forming apparatus according to claim 11, wherein a part of the information about environmental burden is information indicating power consumed during operation of the image forming apparatus.

13. The image forming apparatus according to claim 1, wherein the predetermined screen performs display switching between a first area and a second area, wherein the first area includes the at least one of pieces of information about consumables for the image forming apparatus or the at least one of pieces of information about environmental burden based on printing processing executed by the image forming apparatus, and wherein the second area includes information indicating an operation status of a job to be executed by the image forming apparatus.

14. The image forming apparatus according to claim 13, the at least one processor executing the stored program is caused to:
set a predetermined setting indicating whether the first area or the second area is to be displayed in a case where the predetermined screen is displayed,
wherein, in a case where the predetermined screen is displayed, the first area or the second area is displayed based on the predetermined setting.

15. The image forming apparatus according to claim 14, wherein the at least one processor executing the stored program is caused to:
set a first setting and a second setting, the first setting causing the predetermined setting to be set for each user account logged into the image forming apparatus and the second setting causing the predetermined setting to be set for the image forming apparatus regardless of a user account logged into the image forming apparatus,
display of the first area or the second area set based on the first setting in a case where a user account has logged into the image forming apparatus and
display the first area or the second area set based on the second setting in a case where the user account has not logged into the image forming apparatus.

16. A method of an image forming apparatus, the method comprising:
displaying information about the image forming apparatus on a display unit,
wherein displaying the information includes displaying a predetermined screen including at least one of pieces of information about consumables for the image forming apparatus and at least one of pieces of information about environmental burden based on a job executed by the image forming apparatus.

17. A storage medium storing a program for causing a computer to execute a method, the method comprising:
displaying information about the image forming apparatus on a display unit,
wherein displaying the information includes displaying a predetermined screen including at least one of pieces of information about consumables for the image forming apparatus or at least one of pieces of information about environmental burden based on a job executed by the image forming apparatus.
